(19) United States
(12) Patent Application Publication
(10) Pub. No.: US 2007/0136191 A1
(43) Pub. Date: Jun. 14, 2007

(54) Electronic funds transfer

(75) Inventor: Mark Itwaru, Toronto (CA)

Correspondence Address: MARSHALL, GERSTEIN & BORUN LLP, 233 S. WACKER DRIVE, SUITE 6300, SEARS TOWER, CHICAGO, IL, 60606, US

(73) Assignee: NAVAHO NETWORKS INC., Toronto (CA)

(21) Appl. No.: 11/302,661

(22) Filed: Dec. 14, 2005

(51) Int. Cl. G06Q 40/00

(52) U.S. Cl. 705/40

(57) ABSTRACT

A consumer may make an electronic bill payment from his financial institution account to an intermediary for a certain amount. Data related to the bill payment transaction may be sent to a facilitation server associated with the intermediary. This data may be filtered to determine whether or not the data represents a valid bill payment transaction. If it does, an intermediate account provided by the intermediary, or an account of a third party (such as an on-line merchant) may be immediately credited with the amount of the bill payment so that the consumer can immediately use those funds in an on-line purchase.

### BACKGROUND

This invention relates to electronic funds transfers.

Merchandise is commonly offered for sale over the Internet and credit cards are frequently used as a method of payment. When making an on-line purchase with a credit card, the consumer provides a merchant with a credit card number, and the amount of the purchase is charged to the associated credit card account. However, credit cards are susceptible to fraud, especially when used over the Internet, because often no verification is performed to check that the credit card owner has in fact authorized the purchase. Further, many consumers are reluctant to use a credit card over the Internet.

Non-credit card methods of payment for on-line purchases are also known. Non-credit card methods of payment may employ an intermediate account such that a consumer can transfer funds from his personal financial institution account into the intermediate account and then use the funds in the intermediate account in making an on-line purchase. Funds may be transferred into the intermediate account by, for example, using an electronic cheque. When paying for an on-line purchase from an intermediate account the consumer provides the merchant with information identifying his intermediate account such as an UserID and a password.

By using an intermediate account, the consumer ensures that a merchant does not have access to his personal financial institution account, credit card number or other personal financial information. Further, the consumer may choose to keep only a small balance in his intermediate account to minimize loss in the event of theft or fraud. A merchant is motivated to accept payment through an intermediate account because the merchant may gain access to customers who do not have credit cards. Also, an intermediate account provider may guarantee the payment and thereby assume the risk of fraud.

It may take two to five business days before a consumer who has transferred funds into his intermediate account may access those funds. This is a function of the banking system. More specifically, the intermediate account provider will place a hold on deposited funds while the funds are cleared through to the intermediate account. A consumer who does not have enough funds in his intermediate account to pay for his on-line purchase will therefore have to wait for the funds to clear before he can complete his purchase.

There is, therefore, a need for an improved approach to electronic funds transfer.

### SUMMARY OF THE INVENTION

A consumer may make an electronic bill payment from his financial institution account to an intermediary for a certain amount. Data related to the bill payment transaction may be sent to a facilitation server associated with the intermediary. This data may be filtered to determine whether or not the data represents a valid bill payment transaction. If it does, an intermediate account provided by the intermediary, or an account of a third party (such as an on-line merchant) may be immediately credited with the amount of the bill payment so that the consumer can immediately use those funds in an on-line purchase.

In accordance with this invention, there is provided a method, at a client computer, of facilitating an electronic funds transfer comprising the following. A bill payment transaction is requested, over a public Internet, through a web page interfacing with a financial institution server associated with a first monetary account, to transfer funds from the first monetary account to a second monetary account. Information relating to the bill payment transaction is received from the financial institution server, over the public Internet. Information relating to the bill payment transaction is sent to a facilitation server associated with the second account, over the public Internet.

There is also provided a method, at a client computer, of facilitating an electronic funds transfer, comprising: establishing an user interface; receiving an indication of an on-line banking site of a financial institution from a facilitation server; based on the indication, pointing a web browser for a window on a display to the on-line banking site; on receiving a prompt from the user interface, capturing data displayed in the window and transmitting the data to the facilitation server.

In another aspect of the invention, there is provided a method, at a server, of facilitating an electronic funds transfer, comprising the following. On request from a client computer, an indication of an on-line banking site of a financial institution is sent to the client. Data is received from the client and filtered. Based on the filtering, an account is selectively credited with a deposit amount or confirmation of an amount and a payee is sent to a pre-selected destination.

In a further aspect of the invention, there is provided a method, at a server, of facilitating an electronic funds transfer, comprising: receiving confirmation data originating from a financial institution relating to a bill payment made from a monetary account at said financial institution, said confirmation data identifying a payer, a payee and an amount; filtering said data against filter criteria; and based on said filtering, selectively crediting an account with said amount or sending confirmation of said amount and said payer to a pre-selected destination.

Other aspects of the invention will be apparent from the following description in conjunction with the drawings.

### DESCRIPTION OF THE DRAWINGS

In the figures which illustrate an example embodiment of the invention,

FIG. 1 is a schematic view of a system made in accordance with this invention,

FIG. 2 is a schematic detail view of the facilitation server of FIG. 1,

FIG. 3 is a schematic detail view of the client computer of FIG. 1,

FIG. 4 is a flow diagram illustrating operation of the client computer of FIG. 1,

FIG. 5 is a flow diagram illustrating operation of the facilitation server of FIG. 1,

FIGS. 6a and 6b are diagrams illustrating an user interface of the client computer of FIG. 1,

FIG. 7 illustrates pseudocode for a screen scraping function at the client computer,

FIGS. 8a and b illustrate pseudocode for a parsing function of the parsing and filtering module of FIG. 2,

FIG. 9 illustrates pseudocode for a filtering function of the parsing and filtering module of FIG. 2.

### DETAILED DESCRIPTION

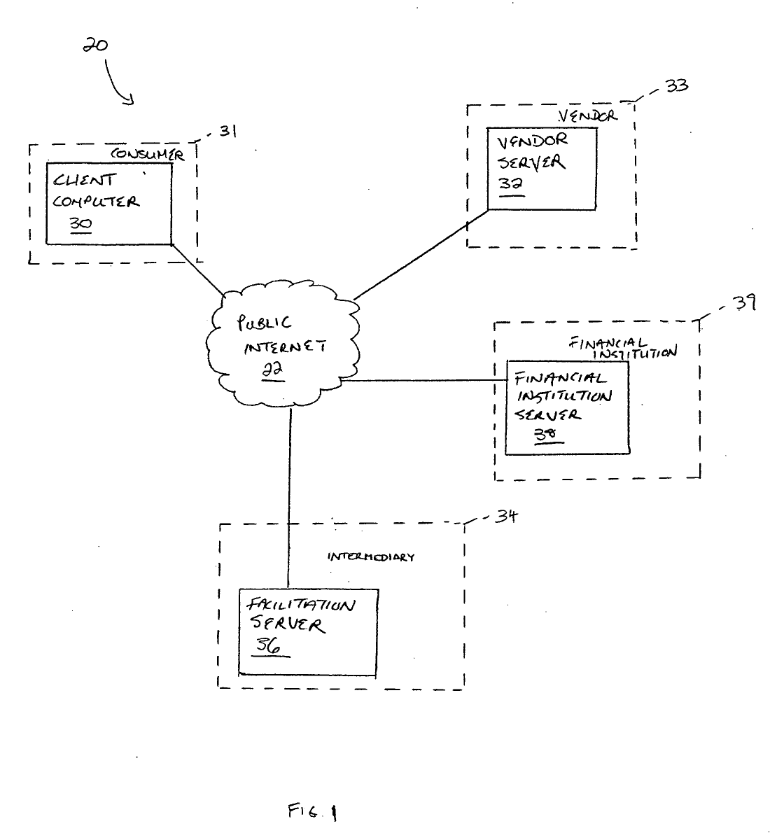

Turning to FIG. 1, a communications system 20 may comprise a client computer 30 associated with a consumer 31, a financial institution server 38 associated with a financial institution 39, a facilitation server 36 associated with an intermediary 34, and a vendor server 32 associated with a vendor 33, connected through the public Internet 22. Vendor 33 may be registered with intermediary 34 so that the vendor server 32 may accept payment through an intermediate account that may be supported by facilitation server 36. For a consumer 31 to use an intermediate account, consumer 31 may first register with his financial institution 39 for on-line banking, and add intermediary 34 holding his intermediate account as bill payee.

In overview, a consumer wishing to use a non-credit card method of payment for an on-line purchase, such as a purchase from vendor 33, may register for an account with intermediary 34 by connecting over the public Internet 22, to facilitation server 36, using his client computer 30. After registration, intermediary 34 may assign the consumer 31 a unique set of identifying information, such as an UserID and a password. Thereafter, the consumer may deposit money into his intermediate account, as follows. The consumer may log into facilitation server 36 over the public Internet 22 using his identifying information and request a deposit. The consumer may then be presented with a number of deposit options, including an instant bill payment deposit.

If the consumer 31 selects the instant bill payment deposit option, he may be presented with a list of financial institutions from which he may select the name of his financial institution. This causes facilitation server 36 to serve up a container web page comprising an user interface button which, when selected, sends data back to facilitation server 36, and an embedded secondary window. If this is the first time that the consumer 31 is visiting the container web page, the consumer 31 is asked to download an application from facilitation server 36 over the public Internet 22 onto his client computer 30. Once the application is installed on client computer 30, it creates an embedded web browser in the secondary window in the container web page. The facilitation server 36 sends an indication (e.g. a universal resource locator (URL)) of the selected financial institution to the client computer 30 so that the embedded web browser is directed to the on-line banking site of the selected financial institution.

Next, the consumer 31 may log into financial institution server 38 through the embedded web page served up by financial institution server 38 using the unique identifying information that his financial institution has assigned him and request a bill payment transaction in a conventional fashion to the intermediary for the amount that he wishes to deposit. When financial institution server 38 accepts a bill payment, as is typical, a confirmation page is received by the client computer 30 for display. Once the confirmation page is displayed, the consumer 31 may select the aforenoted UI button on the container web page. This causes the downloaded application to “scrape” data from the embedded web page and send the data to facilitation server 36 over the public Internet 22. The scraped data may then be parsed by facilitation server 36 and filtered to decide whether or not to credit the consumer's 31 intermediate account with the bill payment amount.

If the consumer's 31 intermediate account is credited with the amount of the bill payment, the consumer 31 may immediately use these funds in an on-line purchase, for example, from vendor 33 through vendor server 32. Further, these funds may be guaranteed to vendor 33, by the intermediary, to be present. If the bill payment transaction is considered invalid, the consumer 31 may be directed either to try again, or to wait for the payment to be credited to his intermediate account within the regular banking holding period.

In deciding to honour the consumers 31 deposit transaction immediately, facilitation server 36 may rely upon data captured directly from the financial institution's bill payment confirmation web page. This provides little chance of fraud on the intermediary by a consumer, and hence, little chance of fraud on a vendor accepting funds from the intermediary. Furthermore, the consumer may immediately complete his on-line purchase without having to wait for the funds to clear from his personal financial institution account through to his intermediate account.

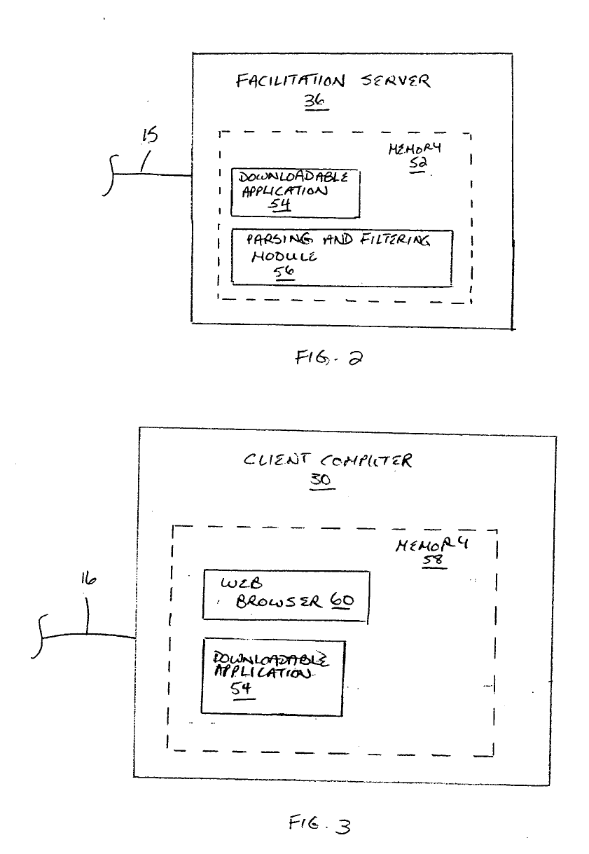

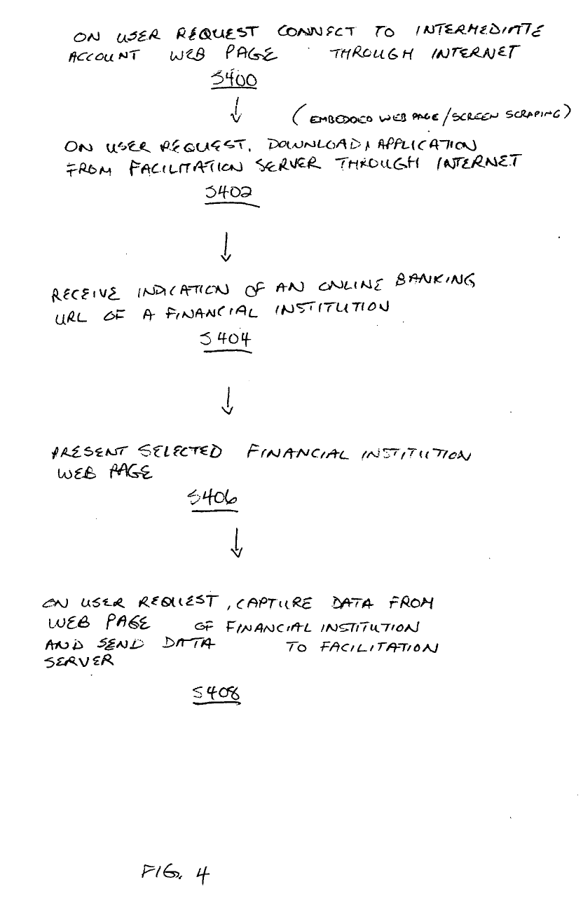

Turning to FIG. 2, facilitation server 36 has a port 15 for connection to the public Internet 22, and a memory 52 which stores a downloadable application 54 and a parsing and filtering module 56. As shown in FIG. 3, client computer 30 has a port 16 for connection to the public Internet 22, and a memory 58, which stores a web browser 60. Web browser 60 may be any conventional web browser, such as Microsoft Internet Explorer™. Further, memory 58 may store downloadable application 54, downloaded from facilitation server 36.

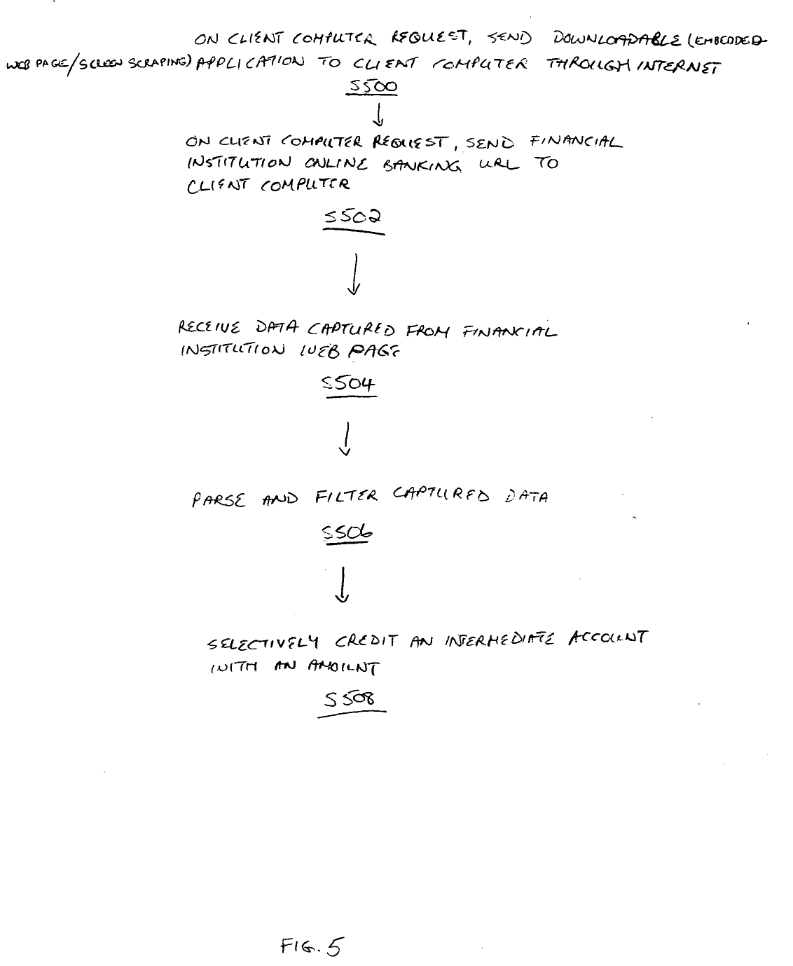

The operation of communications system 20 is described in detail in conjunction with FIGS. 4 to 9.

Client computer 30 may connect to facilitation server 36 associated with an intermediate account over the public Internet 22 in a conventional fashion. The consumer 31 may then select an instant bill payment deposit option from, for example, a drop-down menu on a web page associated with his intermediate account. The consumer 31 may also select a financial institution from, for example, another drop-down menu on the same web page. Facilitation server 36 keeps a record of the selected financial institution.

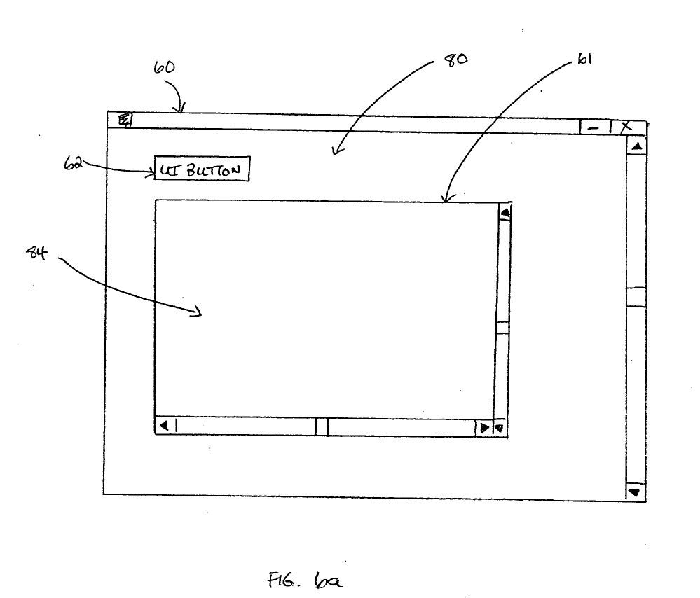

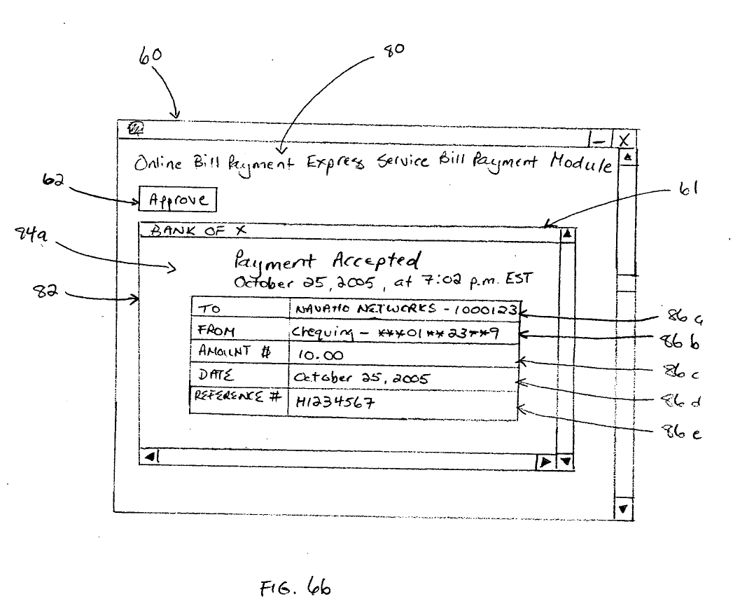

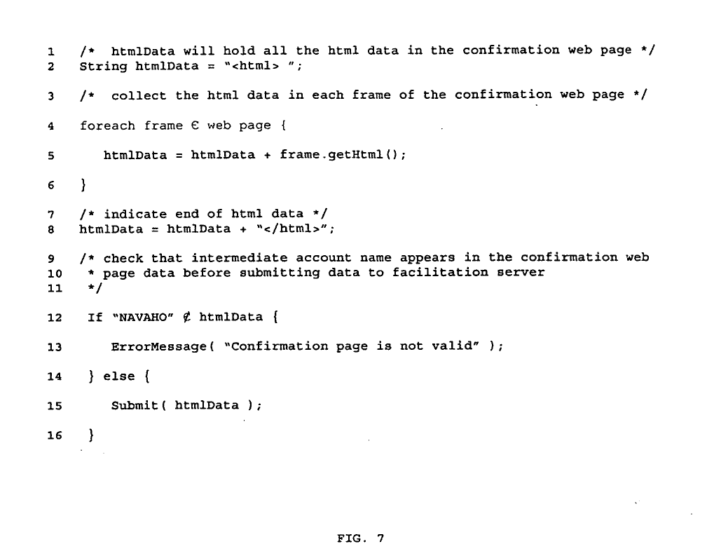

Consumer 31 may then be presented with a web page 80 (FIG. 4, S400; FIG. 6a). Web page 80 may be written in an Internet markup language, or an Internet markup scripting language, or both, and may be downloaded from facilitation server 36 and displayed by web browser 60 (FIG. 6a). If this is the first time that client computer 30 is displaying web page 80, the consumer may be asked to download downloadable application 54 onto client computer 30 from facilitation server 36, through the public Internet 22 (FIG. 4, S402; FIG. 5, S500). Downloadable application 54 may include an ActiveX control object, written in Visual Basic. Downloadable application 54 creates an embedded web browser 61 within web browser 60 (FIG. 6a). As may be appreciated by those skilled in the art, an ActiveX control is a simple OLE (Object Linking and Embedding) object. OLE is a compound document standard developed by Microsoft Corporation which enables software developers to create objects in one application and embed them in another application. (See, for example, http://msdn.microsoft.com/library/default.asp?url=/workshop/components/activex/activex_node_entry.asp, the contents of which are incorporated herein by reference).

Once downloadable application 54 is installed and executing on client computer 30, client computer 30 creates an embedded web browser 61 within web page 80. Client computer 30 may then receive an indication of an on-line banking URL of the selected financial institution from facilitation server 36 (FIG. 4, S404; FIG. 5, S502). Embedded web browser 61 is directed to this on-line banking URL of the selected financial institution, presenting the consumer 31 with a web page 84 associated with the selected financial institution (FIG. 4, S406; FIG. 6a).

Next, the consumer 31 may log into financial institution server 38 and request a bill payment, to be paid on the current day, through embedded web browser 61 in a conventional fashion. When a bill payment transaction is successfully completed, as is typical, financial institution server 38 may return a confirmation web page 84a (FIG. 6b). Confirmation web page 84a typically contains the following fields: the name of the bill payee 86a, an account number of an account from which the amount of the bill payment is deducted 86b, the amount of the bill payment 86c, the date of the bill payment 86d, and a confirmation or reference number 86e (FIG. 6b).

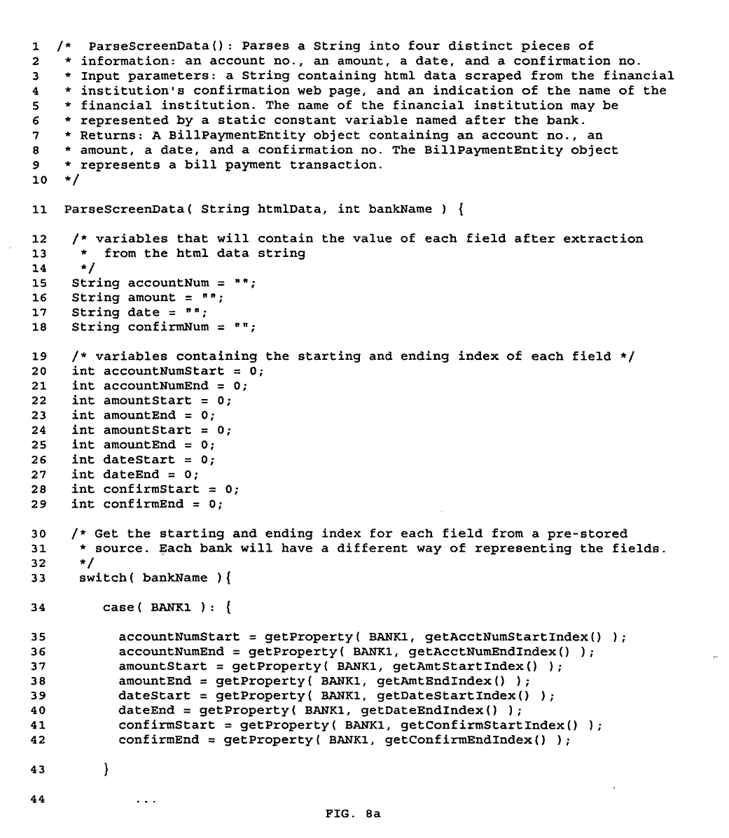

The consumer may be directed, by directions provided on web page 80, to select UI button 62 once confirmation web page 84a is served up by financial institution server 38, in embedded browser 61. When UI button 62 is selected, downloadable application 54 may scrape data captured from confirmation web page 84a and send the captured data to facilitation server 36 (FIG. 4, S408; FIG. 5, S504). Captured data may comprise: the name of the bill payee 86a, the account number 86b, the amount 86c, the date 86d, and the confirmation number 86e (FIG. 6b). In particular, downloadable application 54 may scrape and collect data from confirmation web page 84a by traversing each frame in web page 84a and concatenating the html text into a string-type variable (FIG. 7, I. 4-6) named, for example, htmlData (FIG. 7, I. 2). A check is then performed to ensure that the name of the intermediate account, as bill payee 86a, in this example, “NAVAHO”, is contained in the htmlData string (FIG. 7, I. 12-16). If the name of the intermediate account is not present, an error message may be generated indicating that the confirmation page is invalid (FIG. 7, I. 13). Otherwise, the htmlData string is sent to facilitation server 36 over the public Internet 22 using a standard protocol, such as HTTP/SSL (FIG. 7, I. 15).

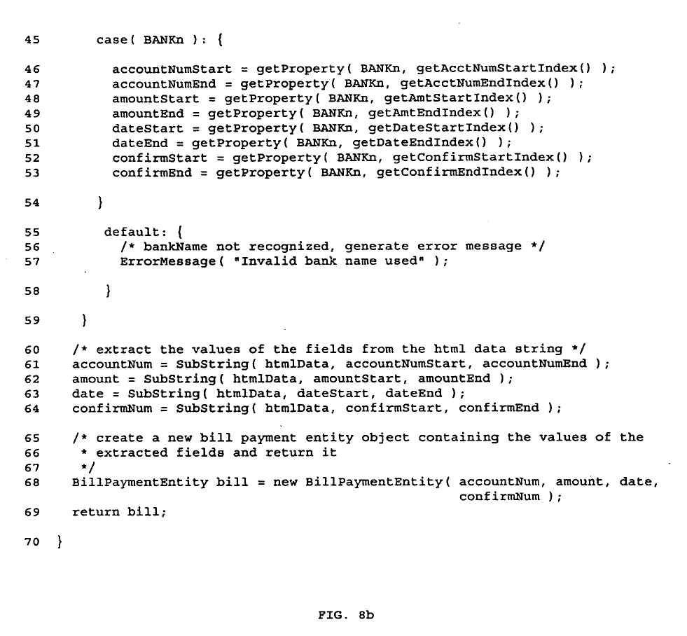

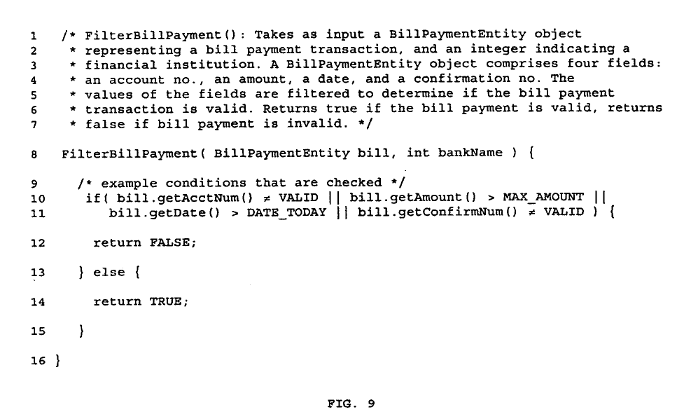

Upon receiving the captured data, encapsulated in the htmlData string (FIG. 7), from client computer 30, facilitation server 36 may parse and filter the data (FIG. 5, S506) using parsing and filtering module 56 located in memory 52 (FIG. 2). Parsing and filtering module 56 may be a program, written in a programming language such as JAVA, which includes two functions: a ParseScreenData( ) function and a FilterBillPayment( ) function (FIGS. 8a and b; FIG. 9).

The ParseScreenData( ) function may take two input parameters: 1) a string containing the captured data from confirmation web page 84a, named, for example, htmlData, and 2) an integer indicating the name of the selected financial institution, named, for example, bankName (FIG. 8a, I. 11). The ParseScreenData( ) function may then parse the htmlData string, into the account number 86b, the amount of the bill payment 86c, the date of the bill payment 86d, and the confirmation number 86e (FIG. 6b). Specifically, variables may be declared to hold the values of the four fields that will be extracted from the htmlData string (FIG. 8a, I. 15-18). Variables containing the starting and ending index of each field within the htmlData string may also be declared (FIG. 8a, I. 20-29). Then, based on the integer indicating the name of the selected financial institution, the starting and ending indices of each of fields 86b to e, within the htmlData string, are determined from a pre-stored record, for example, a data file on facilitation server 36 (FIG. 8a and b, I. 33-59). If the bank name is not recognized, an error message may be generated indicating an invalid bank name (FIG. 8b, I. 55-58). Next, the values of fields 86b to e are extracted from the htmlData string (FIG. 8b, I. 61-64). Finally, a BillPaymentEntity object, which represents a bill payment transaction, is instantiated with the extracted values of fields 86b to e (FIG. 8b, I. 68). ParseScreenData( ) then returns this BillPaymentEntity object to the calling function (FIG. 8b, I. 69).

The FilterBillPayment( ) function may take two input parameters: 1) a BillPaymentEntity object, for example, one returned by a call to the ParseScreenData( ) function (FIG. 9, I. 8), and 2) the integer indicating the name of the selected financial institution. A check is then performed to determine whether the values of the fields 86b to e of the BillPaymentEntity object represents a valid bill payment. If the value(s) are valid, FilterBillPayment( ) returns true, else, it returns false (FIG. 9, I. 10-15). In this example, if one of the following conditions fails, the bill payment is deemed to be invalid: 1) the account number is invalid; 2) the amount of the bill payment exceeds some pre-defined maximum amount; 3) the date of the bill payment is sometime in the future, and not the current day; or 4) the confirmation number is invalid (FIG. 9, I. 10-11). Validity of an account number and a confirmation number may be determined, for example, by comparing the extracted account number 86b and confirmation number 86eto known formats used by the selected financial institution to generate an account number and a confirmation number.

If the bill payment transaction is found to be valid, facilitation server 36 may immediately credit the consumer's intermediate account with the amount of the bill payment (FIG. 5, S508).

Having deposited sufficient funds into his intermediate account, a consumer 31 who wishes to make an on-line purchase from vendor 33 through vendor server 32 may do so in a conventional fashion. And when prompted for a method of payment, the consumer may then transfer funds from his intermediate account to the vendor 33 in a conventional fashion.

In an alternate embodiment of the invention, the fields that are extracted from the data string captured from the confirmation page may include the name of the financial institution, and may also include the name of the bill payee. In this instance, the name of the bill payee may be verified at the facilitation server 36 rather than by downloadable application 54 at the client computer. Further, the captured identity of the financial institution may be compared with the selected financial institution at the facilitation server 36 to act as a further verification. Without this further verification, the identity of the financial institution is implicitly verified by checking the format of the account number and confirmation number with the expected format from the selected financial institution.

In another embodiment of the invention, the account from which a consumer 31 makes a bill payment may itself be an intermediate account, if this account supports a bill payment transaction, and further, also provides a confirmation page which contains data from which the validity of the bill payment transaction may be determined.

In yet another embodiment of the invention, the user interfaces that a consumer 31 interacts with in order to deposit money into his intermediate account need not be web pages accessed through the public Internet 22. Instead, the consumer 31 could log into facilitation server 36 over a private network using a standalone application. This standalone application may allow the consumer 31 to access to, and interact with, financial institution server 38. The screen-scraping and parsing and filtering functions may employ types of textual data other than html.

In yet another embodiment of the invention, the location of the fields that are extracted by the ParseScreenData( ) function within the captured data string may be indicated by means other than the starting and ending indices of the field in the data string. For example, for each financial institution, information may be kept by facilitation server 36 about the name of each examined field and the length of the field. Then, when looking for the value of a particular field in the data string, ParseScreenData( ) may look for the occurrence of the field name within the data string and extract the next x characters in the data string, where x is the known length of the field. These x characters would be the value of the field. Similarly, other types of conditions may be checked by the FilterBillPayment( ) method to determine whether the bill payment transaction should be honoured or not.

In a second embodiment, the operation is identical to that described in conjunction with FIGS. 1 to 9 except that, with reference to FIG. 5, step S508 changes. Specifically, if the data relating to a bill payment transaction passes the tests imposed by the filtering of the data (at S506), the facilitation server 36 does not credit an intermediate account, but instead identifies to an account provider, such as an on-line merchant, a payee and a payment amount. In this embodiment, a consumer, on registration with the intermediary 34, may establish the recipient account provider or, alternatively, whenever the consumer visits the web site of the intermediary, the consumer may identify a recipient for the ensuing bill payment transaction. In this regard, the consumer may be restricted to a list of possible recipients, representing ones which have agreed with the intermediary to accept confirmed payments from the facilitation server.

In another embodiment, the financial institution server may be arranged so that when a consumer completes a bill payment transaction in favour of the intermediary, the financial institution server 38 sends confirmation information directly to the facilitation server 36 of the intermediary 34. The facilitation server parses (where necessary) and filters this confirmation information in order to decide whether to credit the consumer's intermediate account.

This embodiment avoids the need for the client computer to communicate with the intermediary before and after a bill payment transaction. Thus, the downloadable application 54 is not needed (as there is no need for an embedded web page at the client computer and no need to screen scrape confirmation information from the client computer 30).

The set up for operation of this embodiment is as follows. Firstly, the consumer registers for on-line banking with his financial institution and establishes the intermediary as a possible payee in a bill payment on-line banking transaction. Assuming the intermediary and the financial institution have previously established a relationship, in establishing the intermediary as a possible payee, the financial institution server may be configured to provide the consumer with the option of having confirmation of bill payments sent directly to the intermediary, as well as to the consumer. The consumer also needs to register for an intermediate account with the intermediary.

In operation of this embodiment, the consumer may direct the browser of his client computer 30 to the on-line banking site of his financial institution hosted by financial institution server 38. The consumer may select the intermediary as the payee in a bill payment transaction. On completion of the transaction, the financial institution may send a confirmation page to the client computer's web browser and, additionally, may send confirmation information directly to the facilitation server 36 of the intermediary. The facilitation server parses (where necessary) and filters this information and then selectively credits the consumer's intermediate account with the amount of the bill payment.

Other modifications will be apparent to those skilled in the art and, therefore, the invention is defined in the claims.

What is claimed is:

1. A method, at a client computer of facilitating an electronic funds transfer, comprising:
requesting a bill payment transaction, over a public Internet, through a web page interfacing with a financial institution server associated with a first monetary account, to transfer funds from said first monetary account to a second monetary account;
receiving information relating to said bill payment transaction from said financial institution server, over said public Internet;
sending information relating to said bill payment transaction to a facilitation server associated with said second account, over said public Internet.

2. The method of claim 1 wherein said web page interfacing with said financial institution server is downloaded from said financial institution server, over said public Internet.

3. The method of claim 1 wherein said information relating to said bill payment transaction comprises a date and a deposit amount.

4. The method of claim 1 wherein said information relating to said bill payment comprises a confirmation number and an account number associated with said first account.

5. The method of claim 1 further comprising displaying said web page interfacing with said financial institution server within a web page interfacing with said facilitation server.

6. The method of claim 5 further comprising, prior to said requesting, downloading from said facilitation server an application for displaying a web page within a web page of said facilitation server.

7. A method, at a client computer, of facilitating an electronic funds transfer, comprising:
establishing an user interface;
receiving an indication of an on-line banking site of a financial institution from a facilitation server;
based on said indication, pointing a web browser for a window on a display to said on-line banking site;
on receiving a prompt from said user interface, capturing data displayed in said window and transmitting said data to said facilitation server.

8. A method, at a server, of facilitating an electronic funds transfer, comprising:
on request from a client computer, sending an indication of an on-line banking site of a financial institution to said client;
receiving data from said client;
filtering said data;
based on said filtering, selectively crediting an account with a deposit amount or sending confirmation of an amount and a payee to a pre-selected destination.

9. The method of claim 8 wherein said data received from said client computer is a string and further comprising parsing said string into fields before said filtering.

10. The method of claim 9 wherein said fields include a deposit amount field.

11. The method of claim 10 wherein said filtering comprises determining whether data in said deposit amount field represents a deposit amount that is less than a pre-determined maximum amount.

12. The method of claim 11 wherein said filtering comprises determining if said data received is data from said financial institution indicated by said indication.

13. The method of claim 12 wherein said fields include a payee field and wherein said filtering comprises comparing data in said payee field with a pre-determined payee indication.

14. A method, at a server, of facilitating an electronic funds transfer, comprising:
receiving confirmation data originating from a financial institution relating to a bill payment made from a monetary account at said financial institution, said confirmation data identifying a payer, a payee and an amount;
filtering said data against filter criteria;
based on said filtering, selectively crediting an account with said amount or sending confirmation of said amount and said payer to a pre-selected destination.
